(19) United States
(12) Patent Application Publication
(10) Pub. No.: US 2008/0222129 A1
(43) Pub. Date: Sep. 11, 2008

(54) INHERITANCE OF ATTRIBUTE VALUES IN RELATIONAL DATABASE QUERIES

(76) Inventors: Jeffrey G. Komatsu, Kasson, MN (US); William R. Taylor, Rochester, MN (US); Manivannan Thavasi, Rochester, MN (US)

Correspondence Address: IBM CORPORATION, INTELLECTUAL PROPERTY LAW;DEPT 917, BLDG. 006-1, 3605 HIGHWAY 52 NORTH, ROCHESTER, MN, 55901-7829, US

(21) Appl. No.: 11/681,813

(22) Filed: Mar. 5, 2007

(51) Int. Cl. G06F 17/30

(52) U.S. Cl. 707/5; 707/E17.067

(57) ABSTRACT

Embodiments of the invention provide techniques for processing a database query that allows data values for attributes of a child database record to be inherited from an associated parent record. A hierarchical query function may automatically determine the inheritance of attribute values in queries of hierarchical data. In the case that a query does not retrieve values for all attributes specified in the query, the missing attribute values are determined from higher levels of the hierarchy.

### BACKGROUND OF THE INVENTION

1. Field of the Invention

The present invention generally relates to computer databases. More specifically, the present invention relates to techniques for providing attribute inheritance in relational database queries.

2. Description of the Related Art

Databases are well known systems for storing, searching, and retrieving information stored in a computer. The most prevalent type of database used today is the relational database, which stores data using a set of tables that may be reorganized and accessed in a number of different ways. Users access information in relational databases using a relational database management system (DBMS).

Each table in a relational database is composed of a set of rows and columns. Each row in a table is hereafter referred as a record. Each record is composed from the columns of the table. Each column typically specifies a name and a data type (e.g., integer, float, string, etc), and may be used to store a common element of data. The data in a given column is hereafter referred to as an attribute. A column with values used to uniquely identify the records of the table is referred to as a key. For example, in a table storing data about patients treated at a hospital, each row (i.e., record) may represent a different patient. The columns of each row store data values (i.e., attribute values) describing a particular patient. Each patient might be referenced using a unique patient identification number stored in a “patient ID” column. In this example, the “patient ID” column acts as a key to identify each record.

Tables that share at least one attribute in common are said to be “related.” Further, tables without a common attribute may be related through other tables that do share common attributes. A path between two tables is often referred to as a “join,” and columns from tables related through a join may be combined to from a new table returned as a set of query results. Queries of a relational database may specify which columns to retrieve data from, how to join the columns together, and conditions (predicates) that must be satisfied for a particular data item to be included in a query result table. Queries are usually composed in query languages. Today, the most widely used query language is Structured Query Language (SQL). However, other query languages are also used. An SQL query is composed from one or more clauses set off by a keyword. Well-known SQL keywords include the SELECT, WHERE, FROM, HAVING, ORDER BY, and GROUP BY keywords.

Relational databases may be used to store hierarchical data, in which database records are organized in a tree-like structure with parent-child relationships. A hierarchical data record may be a parent (i.e., superior) to another record, and may also be a child (i.e., inferior) to yet another record. One commonly used example of hierarchical data records is a Bill of Materials (BOM). BOMs are commonly used in industry to specify the components parts that are required to manufacture a particular product, and a database table may store a BOM for a manufactured product. In a typical BOM, the product represented by the BOM is composed of component parts which are combined into assemblies, which may in turn be combined into larger assemblies, and finally combined into a finished product. Thus, a BOM can be described with a tree-like structure of multiple levels, with the component parts at the bottom levels, the assemblies in the middle levels, and the finished product at the top level. In the exemplary BOM table, the records are organized in parent-child relationships, with the record for a particular assembly as the parent, and the records for the parts that make up the particular assembly as the children.

In some situations, some of the attributes of a child record of hierarchical data may be based on the attributes of a corresponding parent record. For example, a manufacturing company may have the business requirement that all parts included in an assembly must be the same color as the assembly itself. Applying this requirement to the BOM table would mean that any child records would have the same color attributes as the parent records. Also, since a BOM may have multiple levels of parents and children, the color attributes are also propagated to the children of children that may make up the lower levels of the BOM (i.e., “descendants”). In the case where there are several levels of the BOM and there are several children per parent, the number of affected descendants can grow rapidly. Thus, a color attribute set for a single record at a high level of the BOM could result in the same attribute being stored in many records at various lower levels of the hierarchy. In addition, if the color attribute is changed multiple times, the changes also have to be made multiple times to each descendant record. Such repeated storage of the same color attribute may consume a substantial portion of the resources available for the database (e.g., storage space and processing bandwidth), as well as an increased likelihood for data errors.

One solution to this type of problem is to store attribute values in a small number of parent records, and populate the attribute values of descendant records based on the query results of the parent records. However, this approach typically requires additional processing query results to populate the various levels of the hierarchy. That is, a database query is used to retrieve data for a parent record, and post-query processing is used to propagate data values to child records that share the data value. However, this additional processing often requires custom programming to suit the particular structure of the database and the query. Thus, this approach results in additional work and processing time beyond that required by the query execution.

Therefore, there is a need in the art for techniques for providing the inheritance of attribute values in relational database queries.

### SUMMARY OF THE INVENTION

Embodiments of the invention include a method of providing attribute inheritance in a database query. This method generally includes executing an initial query against a database, where the initial query includes one or more attributes to be returned in an initial query result and where the database stores data values for the attributes in a hierarchy of database records. This method also includes, upon determining data values for one or more of the attributes included in the initial query are not returned in the initial query result, determining whether one or more records of the initial query result have an associated parent record, where the parent records are hierarchically superior to the records of the initial query result in the hierarchy of database records. And if so, executing a second query against the database configured to retrieve data values from the parent records, wherein data values for the attributes not returned in the initial query result are inherited from a second query result.

Embodiments of the invention also include a computer-readable storage medium containing a program which, when executed, performs an operation. This operation generally includes executing an initial query against a database, where the initial query includes one or more attributes to be returned in an initial query result and where the database stores data values for the attributes in a hierarchy of database records. This operation also includes, upon determining data values for one or more of the attributes included in the initial query are not returned in the initial query result, determining whether one or more records of the initial query result have an associated parent record, where the parent records are hierarchically superior to the records of the initial query result in the hierarchy of database records. And if so, executing a second query against the database configured to retrieve data values from the parent records, wherein data values for the attributes not returned in the initial query result are inherited from a second query result.

Embodiments of the invention also include a system having a processor an a memory containing a program which, when executed by the processor, performs an operation. The operation generally includes executing an initial query against a database, where the initial query includes one or more attributes to be returned in an initial query result and where the database stores data values for the attributes in a hierarchy of database records. The operation also includes, upon determining data values for one or more of the attributes included in the initial query are not returned in the initial query result, determining whether one or more records of the initial query result have an associated parent record, where the parent records are hierarchically superior to the records of the initial query result in the hierarchy of database records. And if so, executing a second query against the database configured to retrieve data values from the parent records, wherein data values for the attributes not returned in the initial query result are inherited from a second query result.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 is a block diagram that illustrates a client server view of a computing environment, according to one embodiment of the invention.

FIG. 2 illustrates a hierarchical data structure, according to one embodiment of the invention.

FIGS. 3A-3B illustrate an example BOM table for a manufactured product, according to one embodiment of the invention.

FIG. 4 illustrates a method for providing inheritance of attribute values in relational database queries, according to one embodiment of the invention.

### DETAILED DESCRIPTION OF THE PREFERRED EMBODIMENTS

Embodiments of the present invention provide techniques for inheritance of attribute values in relational database queries. In general, a query of a hierarchical database may determine the attribute values of child records from the attribute values of parent records. In one embodiment, a database management system (DBMS) includes a query function configured to automatically determine the inheritance of attribute values in queries of hierarchical data. When composing a database query, the user includes a search condition within the query. The search condition is used to define a parent-child relation within a table structure. In the case that a query does not retrieve values for all specified attributes, the missing attribute values are determined from higher levels of the hierarchy, based on the parent-child relation specified by the search condition. In the case of a particular attribute value that cannot be determined from higher levels of the hierarchy, the query function returns a null attribute value.

In the following, reference is made to embodiments of the invention. However, it should be understood that the invention is not limited to specific described embodiments. Instead, any combination of the following features and elements, whether related to different embodiments or not, is contemplated to implement and practice the invention. Furthermore, in various embodiments the invention provides numerous advantages over the prior art. However, although embodiments of the invention may achieve advantages over other possible solutions and/or over the prior art, whether or not a particular advantage is achieved by a given embodiment is not limiting of the invention. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

One embodiment of the invention may be implemented as one or more software programs for use with a computer system. The program(s) include instructions for performing embodiments of the invention (including the methods described herein) and may be stored on a variety of computer-readable media. Examples computer-readable media include, but are not limited to: (i) non-writable storage media on which information is permanently stored (e.g., read-only memory devices within a computer such as CD-ROM or DVD-ROM disks readable by a CD-ROM or DVD-ROM drive) and/or (ii) writable storage media on which alterable information is stored (e.g., floppy disks within a diskette drive, hard-disk drives, or flash memory devices). Other media include communications media through which information is conveyed to a computer, such as a computer or telephone network, including wireless communications networks. The latter embodiment specifically includes transmitting information to/from the Internet and other networks. Such computer-readable media, when carrying computer-readable instructions that direct the functions of the present invention, represent embodiments of the present invention.

In general, the routines executed to implement the embodiments of the invention, may be part of an operating system or a specific application, component, program, module, object, or sequence of instructions. The computer program of the present invention typically is comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

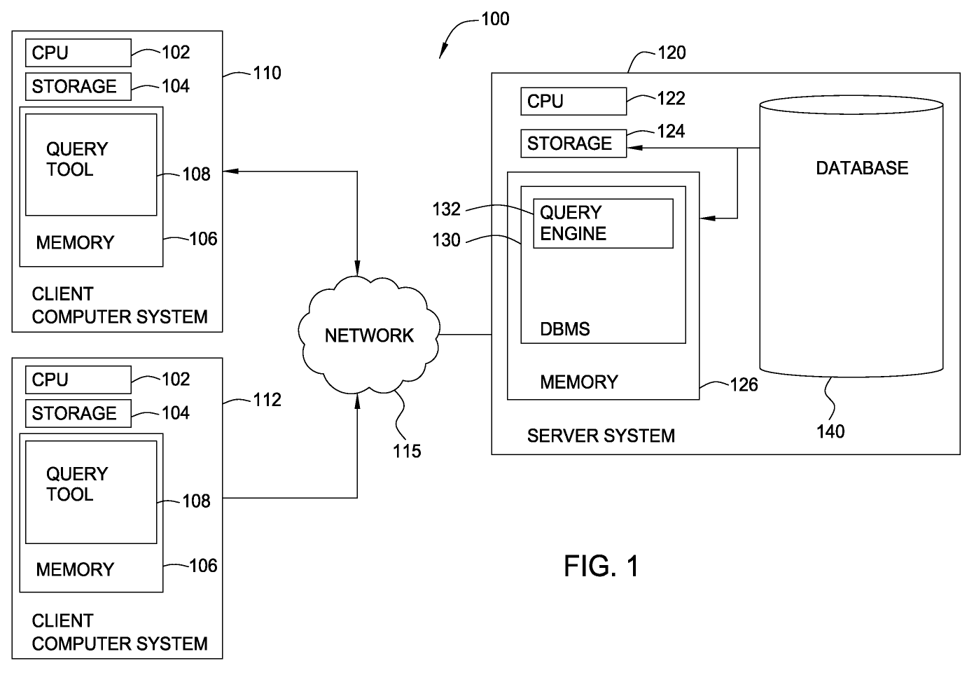

FIG. 1 is a block diagram that illustrates a client server view of computing environment 100, according to one embodiment of the invention. As shown, computing environment 100 includes two client computer systems 110 and 112, network 115 and server system 120. In one embodiment, the computer systems illustrated in environment 100 may include computer existing computer systems, e.g., desktop computers, server computers laptop computers, tablet computers, and the like. The software applications described herein, however, are not limited to any particular computing system, application or network architecture and may be adapted to take advantage of new computing systems as they become available. Additionally, those skilled in the art will recognize that the computer systems shown in FIG. 1 are simplified to highlight aspects of the present invention and that computing systems and networks typically include a variety of additional elements not shown in FIG. 1.

As shown, client computer systems 110 and 112 each include a CPU 102, storage 114 and memory 106, typically connected by a bus (not shown). CPU 102 is a programmable logic device that performs all the instruction, logic, and mathematical processing in a computer. Storage 104 stores application programs and data for use by client computer systems 110 and 112. Storage 104 includes hard-disk drives, flash memory devices, optical media and the like. Network 115 generally represents any kind of data communications network. Accordingly, network 115 may represent both local and wide are networks, including the Internet. Client computer systems 110 and 112 are also shown to include a query tool 108. In one embodiment, query tool 108 is software application that allows end users to access information stored in a database (e.g., database 140). Accordingly, query tool 108 may allow users to compose and submit a query to a database system, which, in response, may be configured to process the query and return a set of query results. Query tool 108 may be configured to compose queries in a database query language, such as Structured Query Language (SQL.)

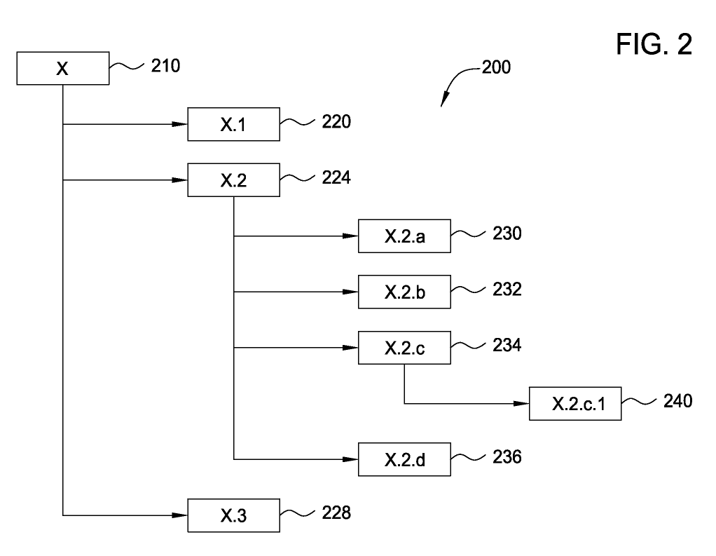

Server 120 also includes a CPU 122, storage 124 and memory 126. As shown, server computer 120 also includes a database management system (DBMS) 130 that includes a query engine 132. The DBMS 130 provides a software application used to organize, analyze, and modify information stored in a database 140. The query engine 132 may be configured to process database queries submitted by a requesting application (e.g., a query generated using query tool 108) and to return a set of query results to the requesting application. Database 140 contains the data managed by DBMS 130. At various times, elements of database 140 may be present in storage 124 and memory 126. In one embodiment, database 140 may store information that is organized in a hierarchical data structure, such as that illustrated in FIG. 2.

FIG. 2 illustrates an exemplary hierarchical data structure 200, according to one embodiment of the invention. As shown, hierarchical data structure 200 (“hierarchy”) includes four levels of data elements. The top level of hierarchy 200 includes an element “X” 210. The second level includes a set of three elements “X.1” 220, “X.2” 224, and “X.3” 226. As indicated by arrows, element “X” 210 is linked to elements “X.1” 220, “X.2” 224, and “X.3” 226. In this example, element “X” 200 is a parent to three child elements “X.1” 220, “X.2” 224, and “X.3” 226. The third level of hierarchy 200 includes a set of four elements “X.2.a” 230, “X.2.b” 232, “X.2.c” 234, and “X.2.d” 236. As shown, the four elements of the third level of hierarchy 200 are children of element “X.2” 224. Finally, the fourth level of hierarchy 200 includes an element “X.2.c.1” 240, which is the child of element “X.2.c” 234. In this example, all elements in the second, third, and fourth levels of hierarchy 200 are descendent from element “X” 210.

The hierarchy 200 may represent the data stored in a database table. For example, hierarchy 200 may represent a Bill of Materials (BOM) table describing the parts of a manufactured product. In such a case, element “X” 210 at the top level of hierarchy 200 may represent the manufactured product. Elements “X.2” 224 and “X.2.c” 234 may be assemblies composed of child elements. Elements “X.1” 220, “X.3” 228, “X.2.a” 230, “X.2.b” 232, “X.2.d” 236, and “X.2.c.1” 240 may be component parts. Of course, depending on the actual data, and the hierarchical relationships, the elements and structure of a hierarchical table will vary.

In one embodiment, hierarchical data may be stored so that attribute values are only populated in a small number of parent records. DBMS 130 may include functions configured to run queries wherein the attribute values of child records are based on the attribute values of parent records. That is, if a child record does not have a value for a given attribute, these functions allow the value to be determined, or “inherited,” from the attribute value of a parent record. These functions are referred to herein as hierarchical query functions. Using hierarchical query functions allows the storage of hierarchical data in tables to be more efficient.

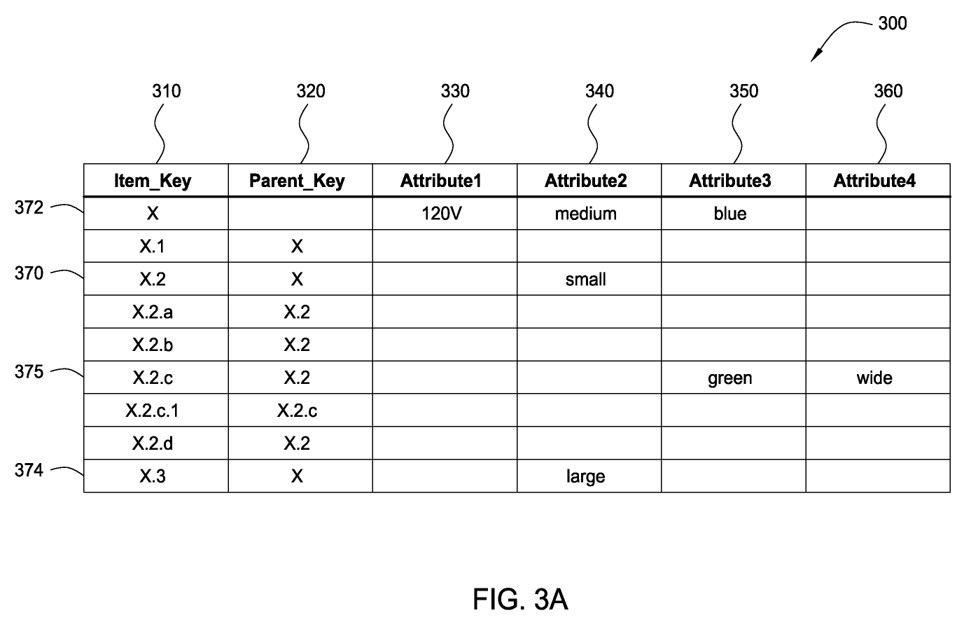

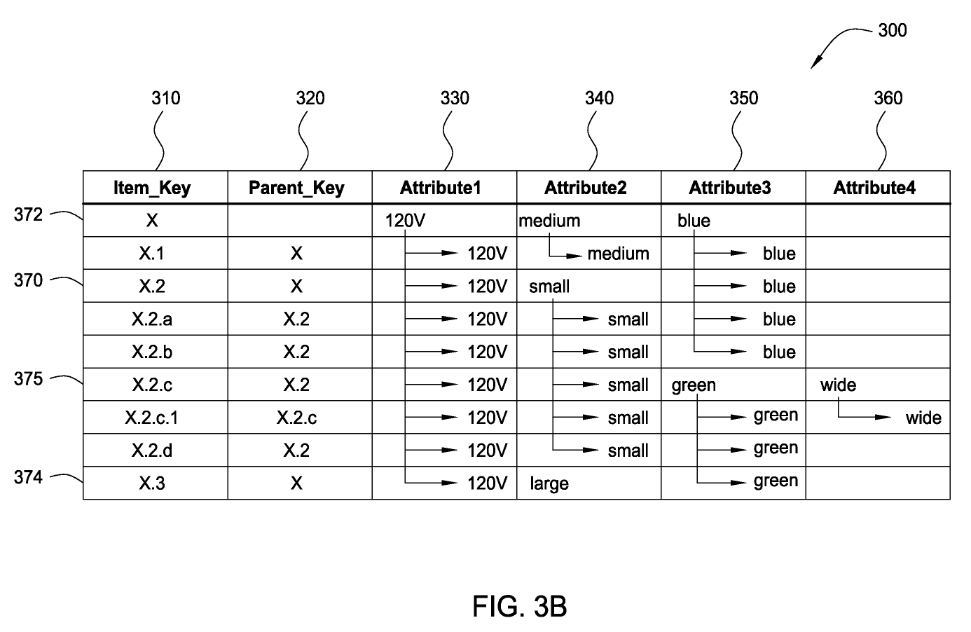

FIGS. 3A-3B illustrate an exemplary BOM table 300 for a manufactured product, according to one embodiment of the invention. As shown in FIG. 3A, the BOM table 300 includes a row (i.e., record) corresponding to the elements of the hierarchy 200 illustrated in FIG. 2. The hierarchical structure of BOM table 300 is established by an “Item_Key” column 310 and a “Parent_Key” column 320. The “Item_Key” column 310 stores a key (i.e., identifier) to identify each record (“X”, “X.1”, “X.2.c”, etc.) The “Parent_Key” column 320 stores the key value for a parent record. That is, the value in the “Parent_Key” column 320 of a child record is the same as the value for the “Item_Key” column 310 of the parent record. For instance, a record 370 includes an “Item_Key” value of “X.2” and a “Parent_Key” value of “X”. The “Parent Key” value indicates that record “X.2” 370 is the child of a parent record “X” 372. In this case, the record “X” 372 describes the top level of the BOM, and is a manufactured product. Typically, the top level of a BOM has no parent. Accordingly, the record “X” 372 has no value specified in the “Parent_Key” column 320.

In this example, BOM table 300 includes a set of four attribute columns 330, 340, 350, 360. Each attribute column stores values for an attribute describing the parts or assemblies included in the BOM table 300. The column “Attribute1” 330 specifies voltage, the column “Attribute2” 340 specifies size, and the column “Attribute3” 350 specifies color. As shown, record “X” 372 includes the value “120V” in the “Attribute1” column 330, the value “medium” in the “Attribute2” column 340, and the value “blue” in the “Attribute3” column 350. Thus, as specified in record “X” 372 of BOM table 300, the manufactured product “X” has a voltage “120V,” is of size “medium,” and has the color “blue.” Similarly, record 370 describes assembly “X.2” which is of size “small,” and record 374 describes component part “X.3” which is of size “large.” More generally, the structure of a database table storing hierarchical data will depend on the particular application required.

In this example, many of the records of BOM table 300 have no values specified in the attribute columns 330, 340, 350, 360. For instance, assembly “X.2” on record 370 has a no value specified in the “Attribute1” column 330. In one embodiment, elements of a hierarchy that do not have values for all attributes may inherit attribute values from parent elements in higher levels of the hierarchy. FIG. 3B illustrates the BOM table 300 after the inheritance of attribute values, according to one embodiment of the invention. As shown, the record “X” 372 has a value of “120V” specified in the “Attribute1” column 330. The remaining records of BOM table 300, which are all descendants of record “X” 372, inherit the value “120V” for the “Attribute1” column 330. In FIG. 3B, the inheritance of the attribute values is illustrated by arrows.

In one embodiment, the inheritance of attribute values may only extend to the next higher level of the hierarchy that has an attribute value. That is, the attribute value may be determined by examining successively higher elements in the hierarchy until a first value for that attribute is found. For example, as shown in FIG. 3B, record “X.2.c.1” 377 of BOM table 300 inherits the “Attribute3” value of “green” from record “X.2.c” 375. However, record “X.2.c.1” 377 does not inherit the value “blue” from record “X” 372, which is higher in the hierarchy than record “X.2.c” 375. Thus, the child record “X.2.c.1” 377 inherits the “Attribute3” value from the next higher of the hierarchy that has a value for the attribute.

Additionally, if a record has no value specified for an attribute, and there are no attribute values higher in the hierarchy, the attribute value is left unspecified (i.e., null value.) For example, as shown in FIG. 3B, record “X.3” 374 has no value specified for the “Attribute4” column 360. Record “X.3” 374 is descendent from record “X” 372, which also has no value specified for the “Attribute4” column 360. Thus, the “Attribute4” value in record “X.3” 374 remains unspecified even after the inheritance of attribute values is determined in BOM table 300.

Further, hierarchical query functions included in DBMS 130 may be configured to return specified attributes for a set of query results that meet a set of specified query conditions. The hierarchical query functions may be called by a query statement which includes a reference to the parent records of the query results. For example, the following Structured Query Language (SQL) query statement is written to retrieve data from the BOM table 300:
SELECT Attribute1, Attribute2, Attribute3 FROM BOM_Table WHERE Item_Key=‘X.2’
   Executing the above query statement would result in the retrieval of the values for attributes “Attribute1,” “Attribute2,” and “Attribute3” for the record of table “BOM_Table” which has “Item_Key” value of “X.2.” Referring to FIG. 3A, the “Item_Key” value of “X.2” points to record “X.2” 370 of BOM table 300. As shown, record “X.2” 370 has the “Attribute2” value of “small.” However, the values for attributes “Attribute1” and “Attribute3” are not specified in record “X.2” 370. Thus, in the prior art, the query results would be missing values for two of the specified attributes.

In one embodiment, a query statement can include keywords to call a hierarchical query function. The above query statement may be rewritten as:
SELECT Attribute1, Attribute2, Attribute3 FROM BOM_Table WHERE Item_Key=‘X.2’ and PKEY=‘Item_Key’ and PVALUE=‘Parent_Key’
   In this case, “PKEY” and “PVALUE” are keywords that cause a hierarchical query function to be performed in executing the query. In other words, the inclusion of these keywords causes DBMS 130 to execute the SQL query with the inheritance of attribute values. The keywords are not data values stored in the database, but are instead used to specify which columns of the table characterize the hierarchy. In this case, the parent record is specified by the query clause “PKEY=‘Item_Key’ and PVALUE=‘Parent_Key’.” The condition “PKEY=‘Item_Key’” identifies the “Item_Key” column 310 as the column in which to search for the key of the parent of the query results record. The condition “PVALUE=‘Parent_Key’” identifies the “Parent_Key” column 320 of the query results record as storing the parent key to search for in the PKEY column. For instance, if the query results records include record “X.2” 370, the parent record may be identified by the PVALUE column, which in this case is the “Parent_Key” column 320. For record “X.2” 370, the value in “Parent_Key” column 320 is “X.” The value “X” is searched for in the PKEY column, which in this case is the “Item_Key” column 310. This results in identifying the parent of record “X.2” 370 as record “X” 372.

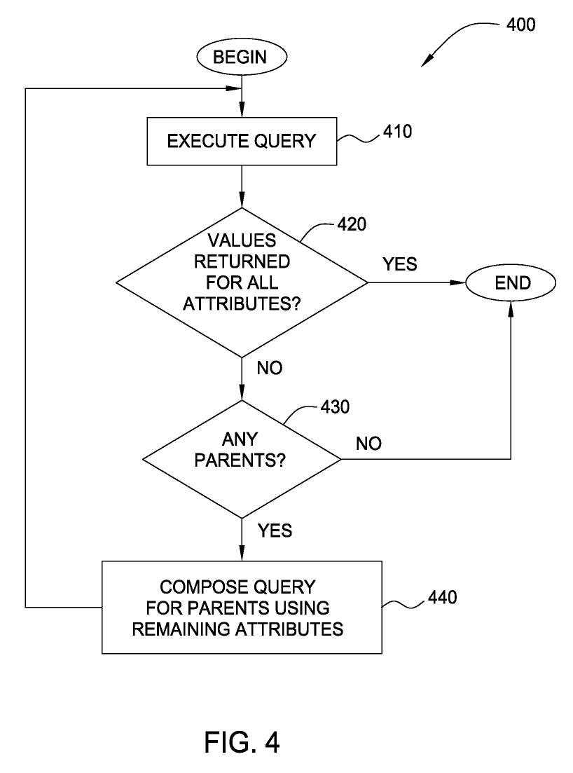

FIG. 4 illustrates a method 400 for providing attribute inheritance in relational database queries, according to one embodiment of the invention. Persons skilled in the art will understand that any system configured to perform the steps of method 400, in any order, is within the scope of the present invention. The method 400 begins at step 410, where a database query is executed. More specifically, the query is executed according to the invention (e.g., including the PVALUE and PKEY keywords). In one embodiment, the database query is composed in the SQL query language, and is executed in a relational database storing hierarchical data. At step 420, the query results are evaluated to determine whether the query results include values for all attributes specified in the query. If so, the method 400 concludes, and the query results are completed. However, if there are missing attribute values (i.e., the query results do not include values for all attributes specified in the query), at step 430, a determination is made of whether there are any parent records to the query result records. In one embodiment, the determination of parent records involves evaluating a parent key column of the records included in the query results, as described above. If there are no parent records, the method 400 concludes, and the query results are completed with null values for any attributes that were not determined. Otherwise, at step 440, a new query is composed to retrieve the missing attribute values from the parent records. The method 400 is then repeated as many times as required to return values for all specified attributes, at which point the method 400 is concluded. In one embodiment, the method 400 may be performed by a database query function configured to determine attribute inheritance, as described above.

For illustrative purposes, embodiments of the invention are described herein in terms of records in one database table. Of course, one of skill in the art will recognize that tables in one or more databases can be joined. Thus, the parent and child records may be in multiple tables, which may be stored in multiple databases.

As described, embodiments of the invention enable the inheritance of attribute values in database queries. Thus, queries of hierarchical data can be performed quickly and efficiently. Further, since no additional processing of the query results is required, there is no need for custom programming. Furthermore, since the tables storing hierarchical data can be configured to eliminate redundant data, the databases can be made smaller and more efficient.

While the foregoing is directed to embodiments of the present invention, other and further embodiments of the invention may be devised without departing from the basic scope thereof, and the scope thereof is determined by the claims that follow.

What is claimed is:

1. A method of providing attribute inheritance in a database query, comprising:
executing an initial query against a database, wherein the initial query includes one or more attributes to be returned in an initial query result, and wherein the database stores data values for the attributes in a hierarchy of database records;
upon determining data values for one or more of the attributes included in the initial query are not returned in the initial query result, determining whether one or more records of the initial query result have an associated parent record, wherein the parent records are hierarchically superior to the records of the initial query result in the hierarchy of database records; and
upon determining one or more records of the initial query result have an associated parent record, executing a second query against the database configured to retrieve data values from the parent records, wherein data values for the attributes not returned in the initial query result are inherited from a second query result.

2. The method of claim 1, wherein the initial query of the database further includes a parent record identifier used to identify the parent record associated with a given record of the initial query result.

3. The method of claim 1, wherein the initial query and the second query are composed in the Structured Query Language (SQL).

4. The method of claim 1, wherein the database is a relational database.

5. The method of claim 1, further comprising:
upon determining data values for one or more of the attributes included in the initial query are not returned in the second query result, determining whether one or more records of the second query result have an associated parent record; and
upon determining one or more records of the second query result have an associated parent record, executing a third query against the database configured to retrieve data values from the parent records of the records of the second query, wherein data values for the attributes not returned in the initial query result and the second query result are inherited from a third query result.

6. The method of claim 5, further comprising, executing successive queries for successively higher levels of the hierarchy of database records until data values for all of the attributes specified the initial query are retrieved from the database.

7. The method of claim 6, further comprising, if the highest level of the hierarchy is reached without retrieving a data value for a given attribute, returning a null value for that attribute.

8. The method of claim 1, further comprising, returning the initial query results to a user, wherein the initial query results include data values for attributes that have been inherited from the results of second query.

9. A computer-readable storage medium containing a program which, when executed, performs an operation, comprising:
executing an initial query against a database, wherein the initial query includes one or more attributes to be returned in an initial query result, and wherein the database stores data values for the attributes in a hierarchy of database records;
upon determining data values for one or more of the attributes included in the initial query are not returned in the initial query result, determining whether one or more records of the initial query result have an associated parent record, wherein the parent records are hierarchically superior to the records of the initial query result in the hierarchy of database records; and
upon determining one or more records of the initial query result have an associated parent record, executing a second query against the database configured to retrieve data values from the parent records, wherein data values for the attributes not returned in the initial query result are inherited from a second query result.

10. The computer-readable storage medium of claim 9, wherein the initial query of the database further includes a parent record identifier used to identify the parent record associated with a given record of the initial query result.

11. The computer-readable storage medium of claim 9, wherein the initial query and the second query are composed in the Structured Query Language (SQL).

12. The computer-readable storage medium of claim 9, wherein the database is a relational database.

13. The computer-readable storage medium of claim 9, wherein the operations further comprise:
upon determining data values for one or more of the attributes included in the initial query are not returned in the second query result, determining whether one or more records of the second query result have an associated parent record; and
upon determining one or more records of the second query result have an associated parent record, executing a third query against the database configured to retrieve data values from the parent records of the records of the second query, wherein data values for the attributes not returned in the initial query result and the second query result are inherited from a third query result.

14. The computer-readable storage medium of claim 13, wherein the operations further comprise, executing successive queries for successively higher levels of the hierarchy of database records until data values for all of the attributes specified the initial query are retrieved from the database.

15. The computer-readable storage medium of claim 14, wherein the operations further comprise, if the highest level of the hierarchy is reached without retrieving a data value for a given attribute, returning a null value for that attribute.

16. The computer-readable storage medium of claim 9, wherein the operations further comprise, returning the initial query results to a user, wherein the initial query results include data values for attributes that have been inherited from the results of second query.

17. A system, comprising:
a processor; and
a memory containing a program which, when executed by the processor, performs an operation, comprising:
executing an initial query against a database, wherein the initial query includes one or more attributes to be returned in an initial query result, and wherein the database stores data values for the attributes in a hierarchy of database records;
upon determining data values for one or more of the attributes included in the initial query are not returned in the initial query result, determining whether one or more records of the initial query result have an associated parent record, wherein the parent records are hierarchically superior to the records of the initial query result in the hierarchy of database records; and
upon determining one or more records of the initial query result have an associated parent record, executing a second query against the database configured to retrieve data values from the parent records, wherein data values for the attributes not returned in the initial query result are inherited from a second query result.

18. The system of claim 17, wherein the initial query of the database further includes a parent record identifier used to identify the parent record associated with a given record of the initial query result.

19. The system of claim 17, wherein the operation further comprises:
upon determining data values for one or more of the attributes included in the initial query are not returned in the second query result, determining whether one or more records of the second query result have an associated parent record; and
upon determining one or more records of the second query result have an associated parent record, executing a third query against the database configured to retrieve data values from the parent records of the records of the second query, wherein data values for the attributes not returned in the initial query result and the second query result are inherited from a third query result.

20. The system of claim 19, wherein the operation further comprises, executing successive queries for successively higher levels of the hierarchy of database records until data values for all of the attributes specified the initial query are retrieved from the database.

21. The system of claim 20, wherein the operation further comprises, if the highest level of the hierarchy is reached without retrieving a data value for a given attribute, returning a null value for that attribute.

22. The system of claim 17, wherein the operation further comprises, returning the initial query results to a user, wherein the initial query results include data values for attributes that have been inherited from the results of second query.
